(19) United States
(12) Patent Application Publication
(10) Pub. No.: US 2014/0258108 A1
(43) Pub. Date: Sep. 11, 2014

(54) SYSTEMS AND METHODS FOR PRODUCT AUTHENTICATION AND CONSUMER RELATIONSHIP MANAGEMENT

(71) Applicant: MASTERCARD INTERNATIONAL INCORPORATED, Purchase, NY (US)

(72) Inventors: Lukas Ekselius, Overijse (BE); Fikret Ates, Namur (BE)

(73) Assignee: MASTERCARD INTERNATIONAL INCORPORATED, Purchase, NY (US)

(21) Appl. No.: 13/794,032

(22) Filed: Mar. 11, 2013

(51) Int. Cl. G06Q 20/32

(52) U.S. Cl. CPC G06Q 20/3227
USPC 705/41

(57) ABSTRACT

In one aspect, processing a product authentication transaction using a transaction terminal includes reading a secure token having a data value corresponding with a product item, determining that the data value is a valid data value corresponding with the product item, and providing an indication that the product item is authentic if the data value is a valid data value corresponding to the product item. In another aspect, processing a product authentication transaction using a terminal connected to a payment network includes reading a secure token having a data value corresponding with a product item, transmitting the data value to an authentication processor, receiving an authentication response from the authentication processor, the authentication response comprising an determination that the data value is a valid data value corresponding to the product item, and providing an indication that the product item is authentic based on the authentication response.

### BACKGROUND

The disclosed subject matter relates to systems and methods for product authentication and consumer relationship management.

Many product manufacturers, particularly producers of luxury-branded and/or high-value products such as designer clothes, fashion accessories, watches, high end consumer electronics, computers, and the like, are concerned with how to protect their brands against counterfeit goods. In 2008, it was estimated that global losses from counterfeiting and piracy exceeded $650 billion per year. A wide range of industries are affected, including pharmaceuticals, medical devices, electronics, computing, high end fashion and accessories, and most luxury brands.

These industries can utilize techniques for authenticating their products—that is, proving that an item is genuine and not a counterfeit reproduction. For example, manufacturers can utilize techniques including trademarks, labels, special packaging and printing techniques, such as holograms. However, these techniques can be circumvented by counterfeiters, which can result in not only brand owners' financial losses, but also consumer health and safety issues and potentially the financing of organized crime. As such, counterfeiting can be a concern to governments and regulatory authorities worldwide.

Authentication can also be utilized in the area of card payments and transaction systems generally. One of the best known payment transaction systems is operated by MasterCard® International Incorporated, which is the assignee hereof. For example, proving that a payment token, such as a plastic card, is genuine can be an objective of many transaction systems. Techniques for authenticating payment cards can include brand marks, special printing, ultraviolet inks, holograms, magnetic stripes, and sophisticated cryptographic techniques. Furthermore, card authentication can utilize global Europay, MasterCard and Visa (EMV) chip infrastructure to authenticate payment cards.

Recently, payment transaction systems have moved into contactless RFID technologies, such as MasterCard®'s PayPass system, which uses proximity technologies based on ISO 14443, which is incorporated by reference herein in its entirety.

There remains an opportunity to utilize authentication infrastructures, such authentication performed in payment card systems, to provide authentication of branded products.

### SUMMARY

Systems and methods for product authentication and consumer interaction using secure tokens are provided.

In one aspect, a method for processing a product authentication transaction using a payment card terminal includes reading a secure token having a data value corresponding with a product item, determining that the data value is a valid data value corresponding with the product item, and providing an indication that the product item is authentic if the data value is a valid data value corresponding to the product item.

In some embodiments, the secure token can include a contact smart chip readable by an EMV payment card terminal. Additionally or alternatively, the secure token can include a contactless chip readable by a contactless payment card terminal. The data value can include a serial number of the product item and/or a product model number of the product item.

In some embodiments, providing the indication can include displaying a visual indicator on an output screen. Additionally or alternatively, providing the indication can include providing a receipt including the data value of the product item. Furthermore, and as embodied herein, the secure token can be embedded in the product item.

In another aspect, a method for processing a product authentication transaction using a terminal connected to a payment network includes reading a secure token having a data value corresponding with a product item, transmitting the data value to an authentication processor, receiving an authentication response from the authentication processor, the authentication response comprising an determination that the data value is a valid data value corresponding to the product item, and providing an indication that the product item is authentic based on the authentication response.

In some embodiments, the terminal can include an NFC-enabled device. The method can further include providing one or more CRM services based on the authenticated product item, and in some embodiments, the one or more CRM services can include one or more of a product offer, a warranty registration, a loyalty program offer, and an interface to access a social networking website.

### BRIEF DESCRIPTION OF THE DRAWINGS

Further features of the invention, its nature, and various advantages will be more apparent from the following detailed description of the preferred embodiments and the accompanying drawings in which:

FIG. 1 is a diagram illustrating an exemplary system for product authentication using a secure token according to the disclosed subject matter.

FIG. 2 is a diagram illustrating an exemplary system for online product authentication according to the disclosed subject matter.

FIG. 3 is a diagram illustrating an exemplary method for product authentication using a secure token according to the disclosed subject matter.

FIG. 4 is a diagram illustrating an exemplary method for online product authentication according to the disclosed subject matter.

FIG. 5 is a diagram illustrating an exemplary computer system according to the disclosed subject matter.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The systems and methods presented herein can be used for product authentication and/or consumer interaction using secure tokens. As used herein, a “product” or “product item” generally can refer to any good, product or material suitable for authentication or consumer interaction according to the disclosed subject matter. As such, the systems and methods presented herein can be utilized for authentication of or interaction with consumers of, for example and without limitation, luxury-branded and/or high-value products such as designer clothes, fashion accessories, watches, jewelry, precious metals, high-end consumer electronics, computers, computer accessories and components, telecommunications equipment, automotive parts, pharmaceuticals, medical devices, or any other suitable goods, products or materials.

As used herein, “secure tokens” or “tokens” generally can refer to any device configured to interact with a terminal of the authentication system and perform tasks related to product authentication and, in some embodiments, facilitate consumer relationship management (CRM) services related to a product authenticated by the authentication system. For example, and as described herein, the term “secure tokens” or “tokens” can include one or more of a contact smart chip, such as a MasterCard® M/Chip, a contactless smart chip, such as a MasterCard® PayPass M/Chip, and/or a NFC-enabled smart device, such as a smartphone, including software configured to interact with an authentication terminal.

According to one aspect of the disclosed subject matter, processing a product authentication transaction using a payment card terminal includes reading a secure token having a data value corresponding with a product item, determining that the data value is a valid data value corresponding with the product item, and providing an indication that the product item is authentic if the data value is a valid data value corresponding to the product item.

According to another aspect of the disclosed subject matter, processing a product authentication transaction using a terminal connected to a payment network includes reading a secure token having a data value corresponding with a product item, transmitting the data value to an authentication processor, receiving an authentication response from the authentication processor, the authentication response comprising an determination that the data value is a valid data value corresponding to the product item, and providing an indication that the product item is authentic based on the authentication response.

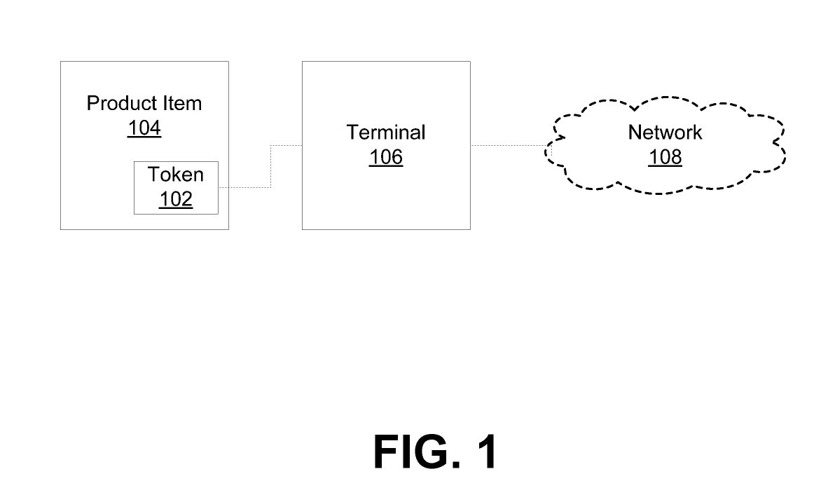

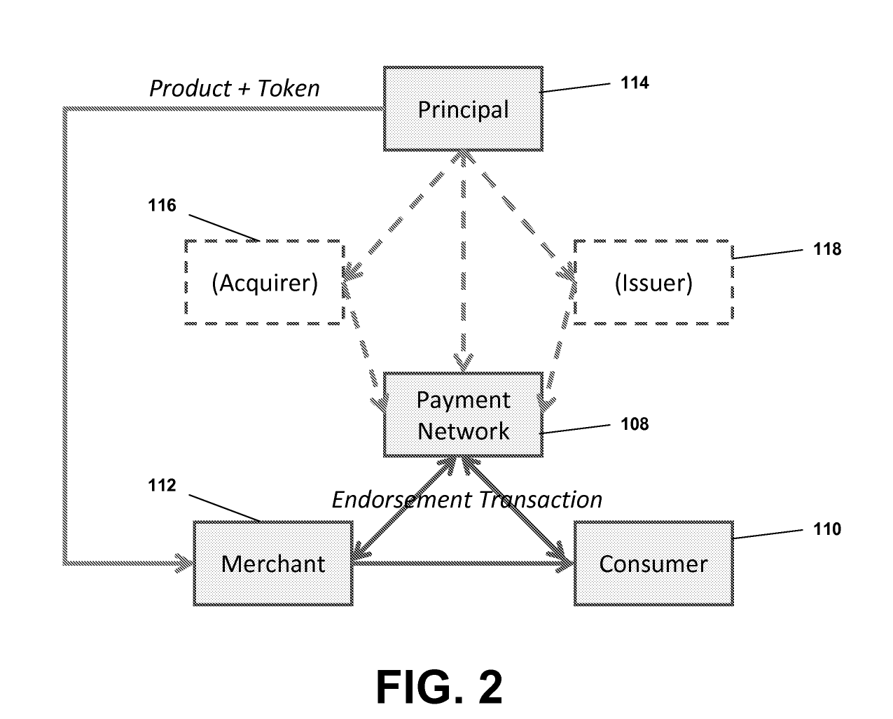

With reference to FIGS. 1-2, and as referred to herein, a “principal” 114 can be, for example and without limitation, a manufacturer, designer or brand owner whose products are to be authenticated by authentication system 100. The principal 114 can also be the “issuer” of the token for each product, or alternatively, the token can be issued by a third-party issuer 118.

A “consumer” 110 can refer to the customer of the principal 114 that purchases products of the principal 114. For purpose of illustration, reference is made herein to consumer 110 as a product purchaser. However, consumer 110 can also refer to other entities that are not purchasers of products, including, for example and without limitation, government entities. For example, a consumer 110 can include a border control or customs agent, who can utilize authentication according to the disclosed subject matter to identify counterfeit or stolen products at a port of entry. A consumer 110 can also include local law enforcement officials, who can utilize authentication according to the disclosed subject matter to identify counterfeit or stolen products obtained from criminal suspects.

A “merchant” 112 can refer to a retailer, such as a brick-and-mortar retailer or online retailer, where the products are sold to the consumer. A “payment network” 108 can refer to, for example and without limitation, and as embodied herein, the MasterCard® payment card system interchange network. An “acquirer” 116 can refer to the owner or operator of terminal 106, which, in some embodiments, can be the processor of online transactions at the point of the transaction, and/or a financial institution with which a merchant maintains a banking relationship. For example and without limitation, the acquirer can be the principal 114 itself, a third-party acquirer 116 or the payment network 108 owner. An “issuer” 118 can refer to the entity issuing the token and, in some embodiments, providing online authorization and/or tracking services on behalf of the principal 114. The issuer 118 can be, for example and without limitation, the principal 114 itself, a third-party issuer 118, the payment network 108 owner and/or a financial institution with which a consumer maintains a banking relationship.

FIG. 1 is a schematic diagram illustrating an exemplary product authentication system 100. In an exemplary embodiment, a secure token 102 having a unique code can be embedded within each product item 104, either within the product item 104 itself or in the product packaging, or alternatively, can be provided as a companion card along with the item. The secure token 102 can be read and the product authenticated via a terminal 106. For example and without limitation, terminal 106 can include a contact or contactless payment terminal, which can be an EMV-compliant terminal. Additionally or alternatively, terminal 106 can include a user-operated terminal based on an NFC-enabled mobile phone running appropriate software, as discussed further below. Additionally, as discussed further below, terminal 106 can communicate with a payment network 108, such as the MasterCard® payment card system interchange network, to provide additional services, such as CRM services related to the product item 104.

Secure token 102 can include unique data within a chip, on a chip card or a chip with NFC capability embedded within the item to be endorsed. For example, secure token 102 can be embedded as a chip, such as an EMV-compliant or PayPass-compliant chip, within the label or trademark on the product item 104. Additionally or alternatively, the secure token 102 can be provided in a “companion card,” that is, a card having a token with unique data associated with the product item 104. The companion card can, for example, be included inside the packaging for product item 104 or provided by the merchant 112 to the consumer 110 at the time of purchase.

The unique data can include the product code or serial number of the product item to be endorsed. As such, verification can be performed, for example by a consumer 110 and/or merchant 112, to verify that the secure token 102 genuinely corresponds to the product item 104. Additional tracking and CRM functions can also be performed, as described below. Alternatively, the unique data may not include the product code or serial number of the product item 104 to be authenticated, but rather can include an authenticatable code that, when validated, can indicate that the product item 104 was associated with a genuine and unique chip.

Terminal 106 can be configured as a Europay, MasterCard and Visa (EMV) merchant terminal, for example where the secure token 102 includes a contact chip, or a contactless PayPass terminal, for example where the secure token 102 includes a contactless chip. Additionally or alternatively, terminal 106 can be configured as an application on an NFC-enabled mobile phone, for example to allow consumers 110 to check the authenticity of product item 104 themselves without needing additional equipment. That is, for example and without limitation, terminal 106 can be an NFC-enabled mobile phone running an application, which can be downloaded by the user to the NEC-enabled mobile phone or otherwise delivered to the NFC-enabled mobile phone using the mobile phone's internet connection. The application when executed by the user can configure the NFC-enabled mobile phone to operate as an EMV-compliant or PayPass-compliant terminal.

In this manner, terminal 106 can read secure token 102 and initiate an authentication response. The authentication response can include, for example and without limitation, displaying a visual indication that the unique data contains a valid authentication code. For example, the authentication response can include confirmation of the product code of the product item 104. That is, if the product item 104 has a product code, such as a product model name, product model number, product trade name or the like associated therewith, the authentication response can include the product code, which can be confirmed by the consumer 110 and/or the merchant 112 that the product code received in the authentication response matches a corresponding product code associated with the product item 104. Additionally or alternatively, the authentication response can include confirmation of a unique serial number of the product item 104. That is, each product item 104, including product item(s) 104 corresponding to the same product code, can be assigned a unique serial number or code that is different from each other product item 104. As such, the authentication response can include the serial number of the product item 104, which can be confirmed by the consumer 110 and/or the merchant 112 that the serial number received in the authentication response matches a corresponding serial number associated with the product item 104. The terminal 106 can be configured to provide a printed receipt including the authentication response information. Terminal 106 reading secure token 102 to authenticate product item 104 can be referred to as an “endorsement transaction.”

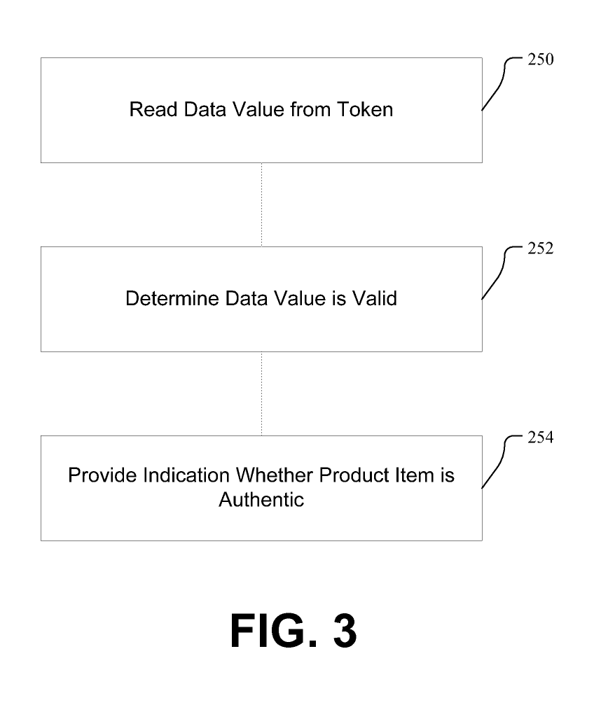

With reference to FIGS. 1 and 3, in an exemplary embodiment, the endorsement transaction can be performed “offline,” that is, with or without the use of a network, such as payment network 108. At 250, terminal 106 can read the secure token 102 of product item 104. The data read from the secure token 102 can include, for example, an encrypted data value encrypted using a public-key infrastructure (PKI), which can include digital certificates stored within each secure token 102. As such, the terminal 106 can decrypt the encrypted data using a public key stored within the terminal 106 to obtain a decrypted data value. In this manner, the endorsement transaction can utilize the MasterCard® worldwide PKI, such as those utilized to authenticate chip payment cards at an EMV-compliant terminal.

At 252, terminal 106 can determine that the data value is a valid data value. In an exemplary embodiment, the data value can include an authenticable code that, when validated, can indicate that the product item 104 is associated with a genuine and unique token 102. For example, the data value can be configured as a personal account number (PAN). Determining that the data value is valid can include determining that the data value complies with an appropriate standardized numbering system, such as the ISO/IEC 7812 standard, which is incorporated by reference herein in its entirety. Additionally or alternatively, the data value can include a product code, as described above, corresponding to product item 104. Additionally or alternatively, the data value can include a serial number, as described above, corresponding to product item 104.

At 254, terminal 106 can provide an indication that the product item is valid based at least in part on the determination in 252. For example, if the data value includes an authenticable code, terminal 106 can provide an indication that the code is a valid code. The indication can be, for example, a visual indication that the code, if valid, is “approved” or “valid,” or if invalid, that the code is “declined” or “invalid.” The indication can be presented, for example, on a visual display of the terminal 106 and/or printed on a receipt from terminal 106 or a connected printer. If the data value includes a product code, terminal 106 can display an indication that the data value includes a product code that matches the product code of the product item 104. For example, if the product code of the product item 104 has been input to the terminal 106, terminal 106 can provide a visual indication that the product code of the data value matches the product code of the product item 104. Additionally or alternatively, terminal 106 can display and/or print the product code of the data value, and a user, such as consumer 110 or merchant 112, can verify that the product code of the data value matches the product code of the product item 104. Additionally or alternatively, if the data value includes a serial number, terminal 106 can display an indication that the data value includes a serial number that matches the serial number of the product item 104. For example, if the serial number of the product item 104 has been input to the terminal 106, terminal 106 can provide a visual indication that the serial number of the data value matches the serial number of the product item 104. Additionally or alternatively, terminal 106 can display and/or print the serial number of the data value, and a user, such as consumer 110 or merchant 112, can verify that the serial number of the data value matches the serial number of the product item 104.

In one embodiment, with reference to FIG. 2, the endorsement transaction can be performed “online,” for example using payment network 108 for online authentication. Payment network 108 can be, for example and as embodied herein, the MasterCard® payment card system interchange network. MasterCard® payment card system interchange network is a proprietary communications standard promulgated by MasterCard® International Incorporated® and generally utilized for the exchange of financial transaction data between financial institutions that are members of MasterCard® International Incorporated. (MasterCard® is a registered trademark of MasterCard® International Incorporated located in Purchase, N.Y.) In one embodiment, the terminal 106 may connect to the MasterCard® network via an internet-accessible gateway, using the mobile phone's internet connection. The connection is preferably encrypted via well-known virtual private network techniques. The connection may be accomplished via a Wi-Fi transceiver and/or a cellular transceiver, such as a baseband processor.

FIG. 2 is a diagram illustrating an exemplary system for online product authentication according to the disclosed subject matter. With reference to FIGS. 1-2, in exemplary embodiment, terminal 106 can be configured to perform and offline endorsement transaction, and can have to option to go online, which can allow an issuer 118 to perform additional authentication of the endorsement transaction. As such, principal 114, or issuer 118 or the owner of payment network 108 acting on behalf of principal 114, can have additional control over the endorsement transaction, as discussed further below. Furthermore, terminals 106 configured for online authentication can receive updated software, for example to provide additional tracking features, and can also provide updates to secure tokens 102 accessing the terminal 106, for example for additional tracking and/or CRM services. As a further alternative, authentication system 100 can be configured to communicate with an enterprise resource planning (ERP) system of the principal 114. In this manner, the endorsement transaction information can be communicated to the ERP system, which can utilize the data to perform various ERP functions, for example and without limitation, supply chain management and customer relationship management.

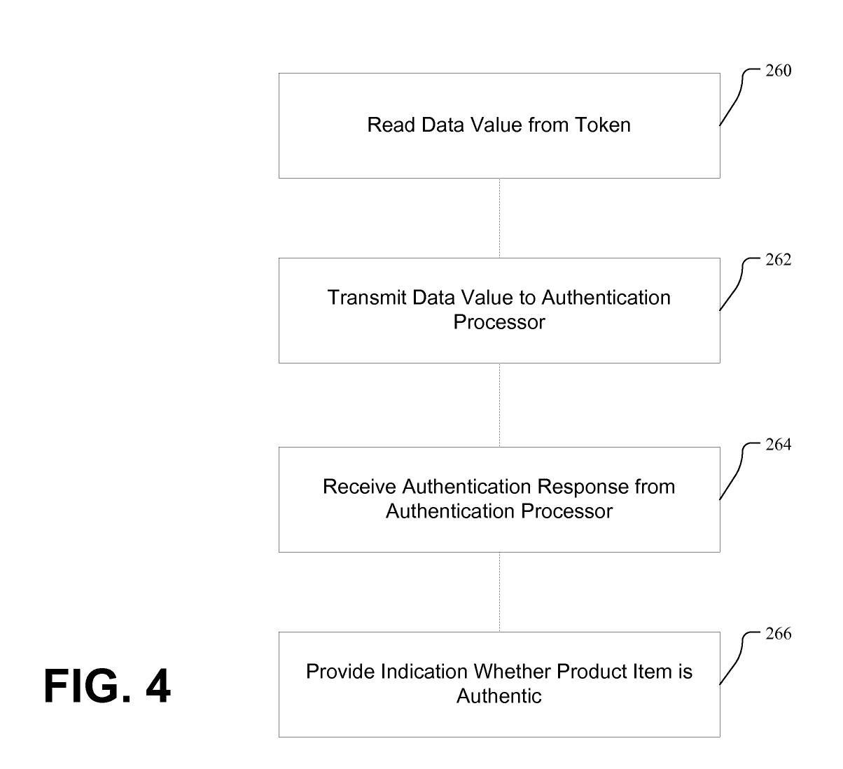

FIG. 4 is a diagram illustrating an exemplary method for online product authentication according to the disclosed subject matter. With reference to FIGS. 1-2 and 4, at 260, terminal 106 can read the secure token 102 of product item 104. As discussed above, secure token 102 can be embedded as a chip, such as an EMV-compliant or PayPass-compliant chip, within the label or trademark on the product item 104, and/or in some embodiments, as a companion card included inside the packaging for product item 104 or provided by the merchant 112 to the consumer 110 at the time of purchase. At 260, for example and as discussed above with respect to 250, terminal 106 can decrypt an encrypted data using a public key stored within the terminal 106 to obtain a data value. Alternatively, terminal 106 can read the encrypted data in secure token 102 without performing any decryption.

At 262, terminal 106 can send the data value to an authentication processor via payment network 108 to authenticate the data value. For example and without limitation, the authentication processor can be a processor operated by a principal 114, or issuer 118 or owner of payment network 108 acting on behalf of principal 114 to authenticate the data value. If the data value received by the authentication processor is encrypted, authentication processor can decrypt the data value, for example as performed by terminal 106 in 250.

The authentication processor can further perform any or all of the determinations performed at 252 by terminal 106. As such, the authentication processor can prepare an authentication response that can include one or more of an indication that an authenticable code in the data value is a valid code, a product code included in the data value, and/or a serial number included in the data value. Furthermore, the authentication processor can be configured to allow principal 114, or issuer 118 or the owner of payment network 108 acting on behalf of principal 114, to have additional control over the endorsement transaction. For example, one or more secure token 102 can be known to be compromised, and the authentication processor can be configured to include a listing of secure token(s) 102 known to be compromised. For example, the listing can include, for example and without limitation, serial number(s) corresponding to one or more product items 104 having a compromised secure token 102 and/or serial number(s) corresponding to one or more product items 104 known to be stolen. If the data value of secure token 102 includes a serial number listed by the authentication processor as being compromised or stolen, the authentication processor can include in the authentication response an indication that the secure token 102 or product item 104 is compromised or stolen. At 264, the authentication processor can send the authentication response via payment network 108 to terminal 106.

At 266, terminal 106 can provide one or more indications to a user based on the authentication response. For example, as discussed above with respect to 254, terminal 106 can provide an indication that the secure token 102 includes a valid authenticable code, and can provide a product code and/or serial number included in the secure token 102. Furthermore, if the authentication response includes an indication that secure token 102 or product item 104 is compromised or stolen, terminal 106 can provide an indication that the secure token 102 or product item 104 is compromised or stolen to the user, for example by displaying and/or printing that the secure token 102 or product item 104 is reported compromised or stolen.

As the “issuer” of the secure token 102 for each product item, principal 114, issuer 118 acting on behalf of principal 114, can be responsible for the endorsement transaction and liable to consumer 110 if the endorsement transaction is false, that is if the endorsement transaction incorrectly indicates that a product item 104 is authentic. Furthermore, owner of payment network 108 can be responsible only for processing the transaction accurately and reliably, and can have strictly limited liability, which can be shifted on to suppliers in most instances (i.e. by analogy with a regular payments network model).

According to another aspect of the disclosed subject matter, the online endorsement transaction can be utilized to perform additional functions, such as data capture/retrieval, tracking, monitoring and/or reporting, which can include one or more services provided to a principal 114 based on authentication of one or more product items 104. For example, terminal 106 and/or the authentication processor can communicate endorsement transaction information for each endorsement transaction to principal 114, or issuer 118 acting on behalf of principal 114, via payment network 108. Additionally or alternatively, the authentication processor can store the endorsement transaction information in a storage medium, which can be accessible by principal 114, for example via an internet-accessible server.

The endorsement transaction information can include, for example and without limitation, for each endorsement transaction, one or more of a date and time of the transaction, a location of the transaction, the product code of the product item 104 authenticated, the serial number of the product item 104 authenticated, whether the transaction indicated that product item 104 was authentic and the owner of terminal 106 performing the transaction. Additionally, the endorsement transaction information can include customer data, for example information obtained from the customer, which can include, without limitation, name, address, demographic information, membership status in a loyalty or reward program, or any other suitable customer information. The authentication processor can include additional product or customer related data in a corresponding authentication response, for example and without limitation, product warranty information, a service reminder for the product, customer purchasing history, and loyalty or reward points earned and/or a point balance for loyalty or reward program.

Furthermore, the endorsement transactions can be performed at any point in a supply chain from principal 114 to consumer 110, and as such, the endorsement transaction information can be utilized by principal 114 to track one or more product items 104 in a supply chain. For example and without limitation, principal 114 can perform an endorsement transaction on a product item 104 using a terminal 106 owned by principal 114. Principal 114 can deliver product item 104 to a wholesaler, who can perform an endorsement transaction on product item 104 using a terminal 106 owned by the wholesaler. Wholesaler can deliver product item 104 to a merchant 112, who can perform an endorsement transaction on product item 104 using a terminal 106 owned by merchant 112, or by acquirer 116 acting on behalf of merchant 112. Consumer 110 can purchase product item 104 from merchant 112, and consumer 110 can perform an endorsement transaction on product item 104 using a terminal 106 owned by consumer 110. For example and without limitation, and as discussed further above, terminal 106 can be configured as an EMV-compliant terminal and/or PayPass-compliant terminal, and in some embodiments can be configured as an NFC-enabled mobile phone running appropriate software to operate as an EMV-compliant or PayPass-compliant terminal. In this manner, principal 114 can receive and/or view a report of the endorsement transaction information for each endorsement transaction performed in the supply chain.

Additionally, for example and without limitation, the endorsement transaction information can allow principal 114 to determine sales volume of product item(s) 104 along the supply chain. The endorsement transaction information can be utilized by principal 114 to make decisions regarding replenishment needs at various points in the supply chain. For example, if a predetermined number of product item(s) 104 delivered to a wholesaler have been sold to one or more merchants 112, which can be determined based, for example, on authentication of the product item(s) 104 by the one or more merchants 112, principal 114 can allocate additional units of product item(s) 104 to the wholesaler. Furthermore, if a predetermined number of product item(s) 104 delivered to a merchant 112 have been sold to one or more consumers 110, which can be determine based, for example, on authentication of the product item(s) by one or more consumers 110, principal 114 and/or a wholesaler acting on behalf of principal 114 can allocate additional units of product item(s) 104 to the merchant 112. In this manner, the merchant 112 and/or wholesaler can provide incremental info about the number of product items 104 remaining in stock. Additionally or alternatively, the merchant 112 and/or wholesaler can provide a total number of product items 104 remaining in stock in endorsement transaction information.

As a further example, the merchant 112 can include information in an endorsement transaction indicating if the endorsement transaction is part of a new sale, return, exchange, repair, warranty claim, or the like. In this manner, the principal 114 can utilize the endorsement transaction information, for example, to identify issues related to customer satisfaction, product quality and product reliability.

According to another aspect of the disclosed subject matter, the online endorsement transaction can be utilized to perform CRM services, which can include one or more services provided to a consumer 110 upon authentication of a product item 104. For purpose of illustration and not limitation, a consumer 110 authenticating a product item 104 using a terminal 106, without limitation and as embodied herein as an NFC-enabled smart phone configured as a terminal 106, can be presented with a variety of CRM services. For example and without limitation, a consumer 110 can be presented with a prompt to register for a warranty or purchase an extended warranty. That is, for example, by pressing a button or tapping on a portion of the display of the terminal 106, consumer 110 can be directed to a web site or to download an application to allow the consumer 110 to provide registration information, such as the consumer's name, residence address, email address and/or phone number, to register for a warranty for product item 104. The endorsement transaction information associated with the consumer's endorsement transaction can also be included in the registration for the warranty. Additionally or alternatively, consumer 110 can further be presented with an option to purchase an extended warranty, and can provide payment information to purchase the extended warranty via terminal 106.

As a further example, a consumer 110 authenticating a product item 104 using a terminal 106 can be presented with a prompt to enroll in a loyalty program or preferred customer club of the principal 114 and/or merchant 112. That is, for example, by pressing a button or tapping on a portion of the display of the terminal 106, consumer 110 can be directed to a web site or to download an application provided by principal 114 and/or merchant 112 to allow the consumer 110 to provide registration information to register for a corresponding loyalty program. The endorsement transaction information associated with the consumer's endorsement transaction can also be included in the registration for the loyalty program. Alternatively, if the consumer 110 is already a member of the loyalty program, the endorsement transaction information can be associated with the consumer's existing loyalty program account. As such, for example and without limitation, consumer 110 can be awarded points, based at least in part on the endorsement transaction, that can be redeemed for merchandise and/or discounts from principal 114 and/or merchant 112. Additionally or alternatively, the consumer 110 can be presented with a financial offer, such as a prompt to establish a line of credit or a private label credit card account with the merchant 112 or principal 114.

As another example, consumer 110 can register to receive targeted offers from the principal 114 or related principals 114 or merchants 112. That is, for example, by pressing a button or tapping on a portion of the display of the terminal 106, consumer 110 can be directed to a web site or to download an application provided by principal 114 and/or merchant 112 to allow the consumer 110 to provide registration information to receive targeted offers. The endorsement transaction information associated with the consumer's endorsement transaction can also be included in the registration for targeted offers. As such, the targeted offers can include offers related to the product item 104 and/or determined more likely to be of interested to the consumer 110 based at least in part, for example, on the product model number and/or manufacturer of product item 104 that was authenticated.

As yet another example, a consumer 110 can be presented with a prompt to post information about their purchase to a social media or social networking website, such as Facebook or Twitter. For example, by pressing a button or tapping on a portion of the display of the terminal 106, consumer 110 can be directed to login into one or more social media or social networking websites. For each website, consumer 110 can be prompted to share some or all of the endorsement transaction information, for example to be included in a post to the user's account or to one or more friend's accounts of the user.

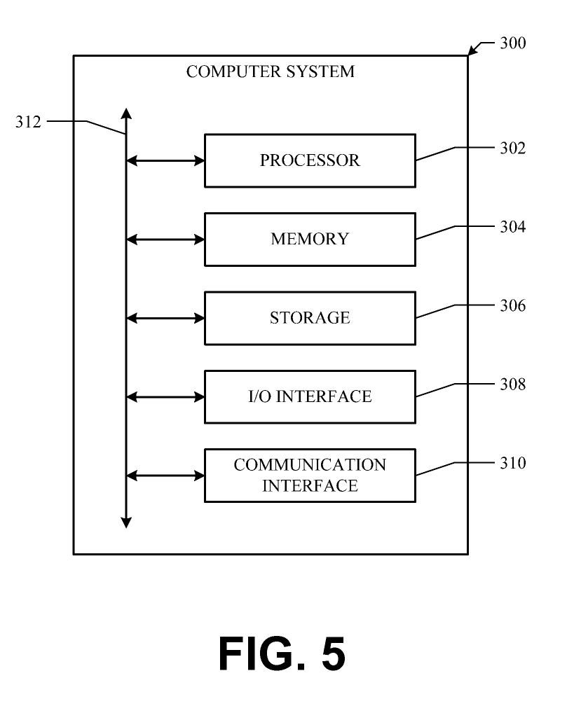

FIG. 5 illustrates an exemplary computer system 300 according to the disclosed subject matter. In some embodiments, one or more computer systems 300 perform one or more steps of one or more methods described or illustrated herein. In some embodiments, one or more computer systems 300 provide functionality described or illustrated herein. In some embodiments, software running on one or more computer systems 300 performs one or more steps of one or more methods described or illustrated herein or provides functionality described or illustrated herein. Some embodiments include one or more portions of one or more computer systems 300. Herein, reference to a computer system can encompass a computing device, and vice versa, where appropriate. Moreover, reference to a computer system can encompass one or more computer systems, where appropriate.

This disclosure contemplates any suitable number of computer systems 300. This disclosure contemplates computer system 300 taking any suitable physical form. As example and not by way of limitation, computer system 300 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 can include one or more computer systems 300; be unitary or distributed; span multiple locations; span multiple machines; span multiple data centers; or reside in a cloud, which can include one or more cloud components in one or more networks. Where appropriate, one or more computer systems 300 can perform without substantial spatial or temporal limitation one or more steps of one or more methods described or illustrated herein. As an example and not by way of limitation, one or more computer systems 300 can perform in real time or in batch mode one or more steps of one or more methods described or illustrated herein. One or more computer systems 300 can perform at different times or at different locations one or more steps of one or more methods described or illustrated herein, where appropriate.

In some embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In some embodiments, processor 302 includes hardware for executing instructions, such as those making up a computer program. As an example and not by way of limitation, to execute instructions, processor 302 can retrieve (or fetch) the instructions from an internal register, an internal cache, memory 304, or storage 306; decode and execute them; and then write one or more results to an internal register, an internal cache, memory 304, or storage 306. In particular embodiments, processor 302 can include one or more internal caches for data, instructions, or addresses. This disclosure contemplates processor 302 including any suitable number of any suitable internal caches, where appropriate. As an example and not by way of limitation, processor 302 can include one or more instruction caches, one or more data caches, and one or more translation lookaside buffers (TLBs). Instructions in the instruction caches can be copies of instructions in memory 304 or storage 306, and the instruction caches can speed up retrieval of those instructions by processor 302. Data in the data caches can be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches can speed up read or write operations by processor 302. The TLBs can speed up virtual-address translation for processor 302. In some embodiments, processor 302 can include one or more internal registers for data, instructions, or addresses. This disclosure contemplates processor 302 including any suitable number of any suitable internal registers, where appropriate. Where appropriate, processor 302 can include one or more arithmetic logic units (ALUs); be a multi-core processor; or include one or more processors 302, each of which may be identical or devoted to different tasks, such as an application processor and a distinct baseband processor. Although this disclosure describes and illustrates a particular processor, this disclosure contemplates any suitable processor or processors.

In some embodiments, memory 304 includes main memory for storing instructions for processor 302 to execute or data for processor 302 to operate on. As an example and not by way of limitation, computer system 300 can load instructions from storage 306 or another source (such as, for example, another computer system 300) to memory 304. Processor 302 can then load the instructions from memory 304 to an internal register or internal cache. To execute the instructions, processor 302 can retrieve the instructions from the internal register or internal cache and decode them. During or after execution of the instructions, processor 302 can write one or more results (which can be intermediate or final results) to the internal register or internal cache. Processor 302 can then write one or more of those results to memory 304. In some embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which can each include an address bus and a data bus) can couple processor 302 to memory 304. Bus 312 can include one or more memory buses, as described below. In particular embodiments, one or more memory management units (MMUs) reside between processor 302 and memory 304 and facilitate accesses to memory 304 requested by processor 302. In some embodiments, memory 304 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 304 can include one or more memories 304, where appropriate. Although this disclosure describes and illustrates particular memory, this disclosure contemplates any suitable memory.

In some embodiments, storage 306 includes mass storage for data or instructions. As an example and not by way of limitation, storage 306 can include a hard disk drive (HDD), a floppy disk drive, flash memory, an optical disc, a magneto-optical disc, magnetic tape, or a Universal Serial Bus (USB) drive or a combination of two or more of these. Storage 306 can include removable or non-removable (or fixed) media, where appropriate. Storage 306 can be internal or external to computer system 300, where appropriate. In some embodiments, storage 306 is non-volatile, solid-state memory. In some embodiments, storage 306 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 can include one or more storage control units facilitating communication between processor 302 and storage 306, where appropriate. Where appropriate, storage 306 can include one or more storages 306. Although this disclosure describes and illustrates particular storage, this disclosure contemplates any suitable storage.

In some embodiments, I/O interface 308 includes hardware, software, or both, providing one or more interfaces for communication between computer system 300 and one or more I/O devices. Computer system 300 can include one or more of these I/O devices, where appropriate. One or more of these I/O devices can enable communication between a person and computer system 300. As an example and not by way of limitation, an I/O device can include a keyboard, keypad, microphone, monitor, mouse, printer, scanner, speaker, still camera, stylus, tablet, touch screen, trackball, video camera, another suitable I/O device or a combination of two or more of these. An I/O device can include one or more sensors. This disclosure contemplates any suitable I/O devices and any suitable I/O interfaces 308 for them. Where appropriate, I/O interface 308 can include one or more device or software drivers enabling processor 302 to drive one or more of these I/O devices. I/O interface 308 can include one or more I/O interfaces 308, where appropriate. Although this disclosure describes and illustrates a particular I/O interface, this disclosure contemplates any suitable I/O interface.

In some embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 300 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 can include any suitable communication interface 310 for any of these networks, where appropriate. Communication interface 310 can include one or more communication interfaces 310, where appropriate. Although this disclosure describes and illustrates a particular communication interface, this disclosure contemplates any suitable communication interface.

In some embodiments, bus 312 includes hardware, software, or both coupling components of computer system 300 to each other. As an example and not by way of limitation, bus 312 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 can include one or more buses 312, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

While there have been described what are believed to be the preferred embodiments of the present invention, those skilled in the art will recognize that further changes and modifications may be made thereto without departing from the spirit of the invention, and it is intended to claim all such changes and modifications that are within the spirit of the invention.

It also will be understood that the systems and methods of the present invention can be implemented using any suitable combination of hardware and software. The software (i.e., instructions) for implementing and operating the aforementioned systems and methods can be provided on computer-readable media, which can include without limitation, firmware, memory, storage devices, micro controllers, microprocessors, integrated circuits, ASICS, on-line downloadable media, and other available media.

1. A method for processing a product authentication transaction using a transaction terminal, the method comprising:
reading, by the transaction terminal, a secure token having a data value corresponding with a product item;
determining, by the transaction terminal, that the data value is a valid data value corresponding with the product item; and
providing, by the transaction terminal, an indication that the product item is authentic if the data value is a valid data value corresponding to the product item.

2. The method of claim 1, wherein the secure token comprises a contact smart chip readable by an EMV-compliant transaction terminal.

3. The method of claim 1, wherein the secure token comprises a contactless chip readable by a contactless transaction terminal.

4. The method of claim 1, wherein the data value comprises a serial number of the product item.

5. The method of claim 1, wherein the data value comprises a product model number of the product item.

6. The method of claim 1, wherein providing the indication comprises displaying a visual indicator on an output screen.

7. The method of claim 1, wherein providing the indication comprises providing a receipt including the data value of the product item.

8. The method of claim 1, wherein the secure token is embedded in the product item.

9. A method for processing a product authentication transaction using a terminal connected to a payment network, the method comprising:
reading, by the terminal, a secure token having a data value corresponding with a product item;
transmitting, by the terminal via the payment network, the data value to an authentication processor;
receiving, by the terminal via the payment network, an authentication response from the authentication processor, the authentication response comprising an determination that the data value is a valid data value corresponding to the product item; and
providing, by the terminal, an indication that the product item is authentic based on the authentication response.

10. The method of claim 9, wherein the secure token comprises a contact smart chip and the terminal is an EMV payment card terminal.

11. The method of claim 9, wherein the secure token comprises a contactless chip and the terminal comprises a contactless transaction terminal.

12. The method of claim 9, wherein the terminal comprises an NFC-enabled device.

13. The method of claim 12, further comprising providing, by the terminal, one or more CRM services based on the authenticated product item.

14. The method of claim 13, wherein the one or more CRM services comprises one or more of a product offer, a warranty registration, a loyalty program offer, and an interface to access a social networking website.

15. The method of claim 9, wherein the secure token is embedded in the product item.

16. The method of claim 9, further comprising providing product authentication transaction information via the payment network to one or more of a principal, an issuer and an owner of the payment network.

17. A transaction terminal for processing a product authentication transaction, the transaction terminal comprising:
one or more processors; and
one or more computer readable storage media embodying software that is configured when executed by one or more of the processors to:
read a data value from a secure token, the data value corresponding with a product item;
determine that the data value is a valid data value corresponding with the product item; and
providing an indication that the product item is authentic if the data value is a valid data value corresponding to the product item.

18. The terminal of claim 17, wherein the secure token comprises a contact smart chip readable by an EMV-compliant transaction terminal.

19. The terminal of claim 17, wherein the secure token comprises a contactless chip readable by a contactless transaction terminal.

20. The terminal of claim 17, wherein the data value comprises a serial number of the product item.

21. The terminal of claim 17, wherein the data value comprises a product model number of the product item.

22. The terminal of claim 17, wherein the indication comprises a visual indicator, the terminal further comprising an output screen to display the visual indicator.

23. The terminal of claim 17, wherein the indication comprises a receipt including the data value, the terminal further comprising a printer to provide the receipt.

24. The terminal of claim 17, wherein the secure token is embedded in the product item.

25. A terminal for processing a product authentication transaction using a payment network in communication with the terminal, the terminal comprising:
one or more processors; and
one or more computer readable storage media embodying software that is configured when executed by one or more of the processors to:
read a secure token having a data value corresponding with a product item;
transmit, via the payment network, the data value to an authentication processor;
receive, via the payment network, an authentication response from the authentication processor, the authentication response comprising an determination that the data value is a valid data value corresponding to the product item; and
provide an indication that the product item is authentic based on the authentication response.

26. The terminal of claim 25, wherein the secure token comprises a contact smart chip readable by an EMV-compliant transaction terminal.

27. The terminal of claim 25, wherein the secure token comprises a contactless chip readable by a contactless transaction terminal.

28. The terminal of claim 25, wherein the secure token comprises an NFC-enabled transmitter, the terminal further comprising an NFC-enabled transceiver.

29. The terminal of claim 28, wherein the software is further configured to provide one or more CRM services based on the authenticated product item.

30. The terminal of claim 29, wherein one or more CRM services comprises one or more of a product offer, a warranty registration, a loyalty program offer, and an interface to access a social networking website.

31. The terminal of claim 25, wherein the secure token is embedded in the product item.

32. The terminal of claim 25, wherein the software is further configured to provide product authentication information to one or more of a principal, an issuer and an owner of the payment network.

33. The terminal of claim 25, wherein the terminal comprises a mobile phone having an NFC-enabled transceiver, and the software comprises an application running on the mobile phone.
